(19) United States
(12) Patent Application Publication
(10) Pub. No.: US 2021/0044902 A1
(43) Pub. Date: Feb. 11, 2021

(54) LIGHTWEIGHT SPEAKER DIAPHRAGM

(71) Applicant: Leib Morosow, Brooklyn, NY (US)

(72) Inventor: Leib Morosow, Brooklyn, NY (US)

(21) Appl. No.: 17/083,259

(22) Filed: Oct. 28, 2020

Related U.S. Application Data
(63) Continuation-in-part of application No. 16/400,754, filed on May 1, 2019.
(60) Provisional application No. 63/060,638, filed on Aug. 3, 2020.
(60) Provisional application No. 63/026,755, filed on May 19, 2020.
(60) Provisional application No. 62/926,578, filed on Oct. 28, 2019.

(51) Int. Cl. H04R 7/24

(52) U.S. Cl. CPC H04R 7/24

(57) ABSTRACT

An airtight tensionally stiff speaker diaphragm (i.e. being non-stretch, having a relatively high Young's modulus) which relies on tensile stiffness and air pressure to maintain its shape and produce sound can be extremely lightweight, a lighter spider is also described.

### FIELD OF INVENTION

Speakers.

### BACKGROUND OF INVENTION

Considering that the moving mass of a speaker diaphragm is usually about 20 times that of the moving mass of its air component it can be said that speaker diaphragms are extremely inefficient, and although a cone shape can have a relatively high strength to weight ratio it cannot compare to a speaker diaphragm that relies on tensile stiffness and air pressure to maintain its shape (somewhat like a parachute).

FIG. 1 in patent application US54837455A publication U.S. Pat. No. 2,846,520(A) shows a low frequency speaker with a pressurized enclosure and a sound producing diaphragm with tensile stiffness held taut by the air pressure, this allows the diaphragm to be very lightweight. However issues with this figure include the following, the tension that the diaphragm and the tension members exert on the surround may be unacceptable, also the spring that keeps the diaphragm centered presents problems because a spring that can supply the necessary force must either add a lot of stiffness or a lot of mass to the diaphragm thus hindering its ability to vibrate and defeating the purpose of making it lighter in the first place.

In other words the mass of a spring of a given matter is dictated by the potential energy that it must store, and the potential energy of a spring equals its force squared multiplied by its compliance, so a spring that is compliant enough will have a lot of mass and will therefore have a slow speed of sound so at best it will form waves that will travel back and forth through the spring at the slightly higher frequencies that will create echoes that are distorted due to the lack of absolute symmetry of the spring.

FIG. 2 in the above application shows a mechanism that helps keep the diaphragm centered while applying negative stiffness to the diaphragm by constantly varying the leverage of the springs, however upon close examination said mechanism looks like it will be noisy and will very quickly break down.

A little about leverage, varying leverage and negative stiffness:

Stiffness equals change in force divided by change in position (displacement) i.e. the derivative of force vs position, however whereas (positive) stiffness is a force that increases as you move against it, negative stiffness is a force that decreases as you move against it. e.g. a tall heavy bookshelf leaning against a wall at a forty-five-degree angle, as you try to push it upright you find that, unlike a spring, the farther you push it the less it pushes back at you, that is negative stiffness.

Since negative stiffness is simply a force that varies with position, it can easily be reproduced by combining a simple spring with a device that applies leverage that varies with position, e.g. noncircular gears will apply leverages that vary with position, so will a bookshelf, i.e. gravity has less leverage when the bookshelf is vertical, essentially any mechanism that has interconnected members that move at velocities that vary relative to each other (i.e. being none linearly related) will also result in varying leverages that are correlated to these relative velocities, even the varying x and y velocity components of any single moving member can create varying leverage e.g. the above mentioned bookshelf.

However, it is difficult to create a mechanism that utilizes varying leverage to produce negative stiffness that has a high enough strength to weight ratio and is durable enough (able to survive billions of vibrations) for acoustics as well as for many other vibration related applications like automobiles, HVAC, isolation tables, etc. Magnetic attraction is inherently negatively stiff, i.e. it's a force that gets weaker as you move against it, however its negative stiffness is not nearly constant.

### BRIEF SUMMARY

An airtight tensionally stiff speaker diaphragm (i.e. being non-stretch, having a relatively high Young's modulus) which relies on tensile stiffness and air pressure to maintain its shape and produce sound can be extremely lightweight. Problems relating to utilizing a pressurized speaker enclosure to supply said air pressure are discussed, including reasonable ways to reduce the force on the surround as well as reasonable ways to center the diaphragm despite the air pressure, see FIGS. 1 through 4b.

A spider that adds less mass and less stiffness to a speaker diaphragm is then described, see FIGS. 5 through 6d.

A speaker drivers comprising a pressurized bladder that comprises a tensionally stiff layer (i.e. being non-stretch, having a relatively high Young's modulus) which relies on tensile stiffness and air pressure to maintain its shape and produce sound are then described, see FIGS. 7a through 7c.

### BRIEF DESCRIPTION OF DRAWINGS

FIG. 1 shows a speaker comprising a pressurized enclosure and comprising a lightweight tensionally stiff sound producing diaphragm held taut by the air pressure difference, this allows the diaphragm to maintain its shape while still being very lightweight. Spring-loaded levers pull on said diaphragm to keep it taut and centered.

FIG. 2 shows a speaker similar to the one in FIG. 1 but for a few differences, one being that it uses levers with magnets, instead of springs, to pull on the diaphragm, this can add negative stiffness.

FIG. 3 shows a speaker similar to the one in FIG. 1 except that the voice coil and magnet assembly have been moved to the back.

FIG. 4a shows the back of the speaker from FIG. 1 but comprising an air spring to pull on the diaphragm.

FIG. 4b shows the back of the speaker from FIG. 1 but comprising a negative pressure air spring to pull on the diaphragm.

FIG. 5 shows the new type of spider 18 from FIGS. 1 and 2 that adds less mass and less stiffness to a speaker diaphragm,

FIG. 6a shows inner areas 52 of the new spider separated by gaps 55.

FIG. 6b shows inner areas 52 of the new spider separated by folds 55.

FIG. 6c shows inner areas 52 of the new spider separated by folds 55.

FIG. 6d shows inner areas 52 of the new spider separated by folds 55.

FIG. 7a shows a speaker driver comprising a pressurized bladder that serves as at least part of a diaphragm.

FIG. 7b shows a speaker driver comprising a pressurized bladder that serves as at least part of a diaphragm.

FIG. 7c shows a speaker driver comprising a pressurized bladder that serves as at least part of a diaphragm.

### DETAILED DESCRIPTION

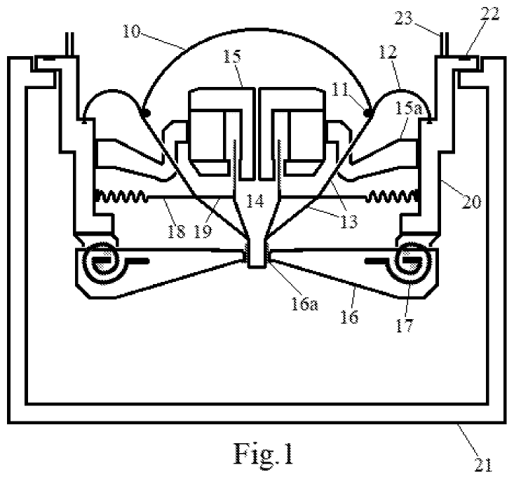

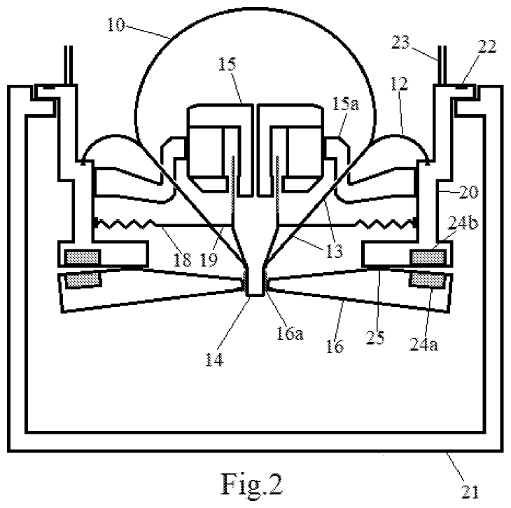

In consideration to what was brought up in the “background” section, FIGS. 1 and 2 show cross sections of partially similar embodiments of a speaker with a pressurized enclosure 21 and a tensionally stiff sound producing diaphragm 10 (i.e. being non-stretch, having a relatively high Young's modulus) held taut by the air (gas) pressure difference, this allows the diaphragm to maintain its shape while still being very lightweight, so any frequency speakers, including subwoofers, woofers, midranges and tweeters, may benefit from this.

A small quiet (insulated) air pump and valve (not shown) can add/remove air to the enclosure 21 as the average position of the diaphragm (slowly) veers away from center, thus recentering it.

Tensionally stiff tension members 13 connect the diaphragm 10 to the former 14, in FIG. 1 the diaphragm 10 is surrounded by a lightweight (possibly hollow) ring 11 that has relatively high compression stiffness, this ring 11 keeps tension off of the surround 12, in FIG. 2 the very obtuse angle at which the diaphragm 10 and tension members 13 meet keeps much of the tension off of the surround 12. The surround 12 too can be made very lightweight since it too can be held taut by the air pressure.

The former 14 has a wide end that holds the voice coil inside the magnet assembly 15, the former 14 also has a narrow end that connects to lightweight levers 16 by way of very short tension members that curve around the slightly convex ends 16a of levers 16. Levers 16 pull on the diaphragm assembly and counter the force applied on the diaphragm 10 by the pressurized air in the enclosure 21. In FIG. 1 the levers 16 get their force from springs 17, and in FIG. 2 the levers get their force from magnets 24b pulling on magnets 24a.

In FIG. 1 the leverage created by levers 16 makes springs 17 appear much less massive and much more compliant than they really are (the effects of leverage on mass and compliance is proportional to the square of the leverage) this will allow the springs 17 to actually be quite stiff, this spring stiffness will eliminate the above mentioned echoes, this spring stiffness will also allow the springs 17 to double as hinges e.g. springs may be the only thing holding the levers 16 in place despite being pulled on by the former 14.

In FIG. 2 the leverage created by levers 16 makes magnets 24a appear much less massive than they really are because they are positioned close to the fulcrum 25 (this will mean that the magnets will need to pull harder but over a shorter distance so more but smaller or narrower magnets will be necessary, but the total magnetic mass need not change). Such magnetic attraction can add negative stiffness to the diaphragm assembly, this can cancel some of the stiffness added by the spider and surround as well as stiffness added by the air in the sealed speaker enclosure, as a result the diaphragm 10 will be easier to move at the lower frequencies.

The lever 16 has a convex side 25 that acts like a fulcrum 25 allowing the lever 16 to rock back and forth, somewhat like the bottom of a rocking chair, but as it rocks the fulcrum point 25 keeps moving, it can move faster than any of the physical parts, thus resulting in a strong moving fulcrum that is not affected by the g-forces that can plague vibrating bodies, and a moving fulcrum (or effort point or load point) means that the leverage keeps changing, this can mathematically simulate stiffness, and a properly shaped convex curve can create a properly shaped stiffness function which if added to the negative stiffness function shape of the magnets can result in a properly shaped negative stiffness function e.g. a linear or constant negative stiffness function (a broader discussion pertaining to this subject of negative stiffness as well as leverage and varying leverage can be found in this application's parent application US201916400754A 2019 May 1).

The levers 16 can also act as a spider in limiting the voice-coil's side to side movement, this is especially true if there are three or more levers surrounding the former 14 or its tapered extension.

A unique spider 18, which adds less mass and less stiffness, is used to keep the voice coil centered, in FIG. 1 said spider 18 also pulls on the tension members 13 resulting in a noticeable bend, this illustrates another way to lower tension on the surround 12, in this case it shares some of this burden with ring 11. Short tensionally stiff tension members 19 connect the former 14 to the spider 18.

Mounting holes 22 for securing the basket 20 to the enclosure 21, said enclosure should be substantially airtight so that it can be pressurized. Projections 23 may support a structure that protects the diaphragm from being punctured.

Each magnet support arm 15a is designed so that it requires only a small opening to pass through the cone-shape of tension members 13 that pull on the diaphragm 10, thus limiting the gap size needed between these tension members 13, this also limits the gap size needed between secondary tension members that run perpendicular, or oblique, to the primary tension members 13 thus forming rings or ellipses or spirals around said cone-shape 13, the secondary tension members are designed to hold and prevent the primary tension members 13 from vibrating in an undesirable manner so some glue or epoxy is in order. The primary tension members 13 may also cross each other (e.g. in a manner somewhat resembling the spokes on a bicycle wheel), this can add rotational stability.

If a spider 18 is positioned close to any magnet support arms 15a it may need to comprise holes or gaps so that it does not bump into said magnet support arms 15a.

With the help of some glue or epoxy primary tension members 13 can be added or repositioned to fill in gaps so that there are no large gaps between primary tension members 13 where they come in contact with, and pull on, the diaphragm.

The compression member 11 that circles the diaphragm 10, and keeps the tension off of the surround 12, may be kept from bending by the diaphragm 10 and the tension members 13 so it may only need to be a few millimeters thick, or less if comprising strong stiff materials like carbon fiber, especially if most of the fibers are arranged longitudinally. Also the thickness of the diaphragm 10 and tension members 13 may be very thin e.g. if the diaphragm 10 comprises carbon fiber or aramid it may be thinner than 50 microns even if the diaphragm 10 is a foot across. Of course, it can be even thinner in a smaller speaker e.g. a midrange or tweeter or a speaker inside of a laptop or cellphone etc. etc.

Whether aramid or carbon fibers etc. relatively long and relatively straight fibers (curving with the diaphragm of course) can make for a stronger diaphragm 10, so if the diaphragm 10 is dome shaped, and woven pieces are used to create said dome, it may be beneficial if they are first cut into long thin strips parallel to half the fibers, that way they can contribute many long straight fibers to the diaphragm 10, although using fibers that are not part of a woven fabric can eliminate the extra weight of the short cross fibers. In a dome shaped diaphragm the fibers may be oriented in all directions to deal with the internal forces.

The diaphragm 10 may firmly hold its shape with the help of air pressure, however, depending on how it is designed, once the air pressure is removed it may become very flexible or just slightly flexible, it may even comprise sections that are less flexible separated by sections that are more flexible, that way it can easily fold along predetermined lines, e.g. patches of epoxy may connect the fibers giving the diaphragm strength and spaces between said patches may be covered in plastic making the diaphragm flexible while keeping it airtight, such gaps in the epoxy may be possible if the fibers are relatively long and relatively straight.

Although a dome is a strong shape for a round diaphragm, flattening the dome a little to save space may be a reasonable compromise, a strong diaphragm shape is usually one that can't easily be reshaped without reducing the volume it helps enclose, also if the shape of the diaphragm changes when the air pressure is raised a little higher than usual, that may be a sign of uneven stresses and that the diaphragm should either be redesigned in the latter shape or that it should comprise extra internal structural support to maintain its former shape.

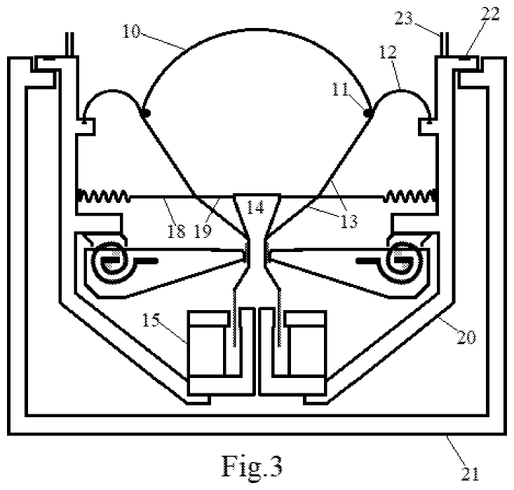

FIG. 3 shows an example of an embodiment similar to the one in FIG. 1 except that the voice coil and magnet assembly 15 have been moved to the back.

Replacing the solid springs with a properly compliant air spring may also mostly resolve the mass and stiffness problems as well as the “echoes” problem without a real need for leverage (because of its lighter weight, and also because air can have more symmetry than a solid spring). Each of the following two figures shows one type of air spring but different types are possible e.g. rolling lobe, convoluted bellows. Air springs may require air pumps and valves (not shown) whose parts may be shared with air pumps and valves (not shown) used to pressurize the speaker enclosure 21

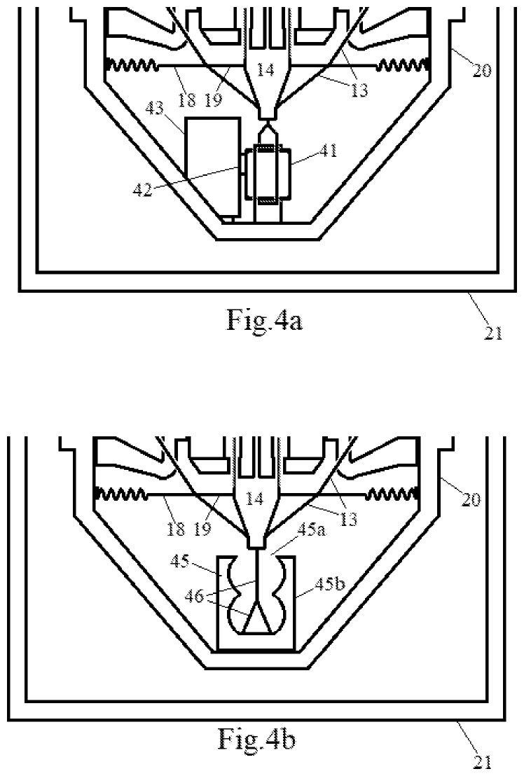

FIG. 4a shows the back of the driver from FIG. 1, but instead of spring loaded levers it comprises an air spring 41 that when it tries to expand pulls on the diaphragm 10 by pulling on the former 14. A very short and wide air path 42 connects said air spring 41 to a large air reservoir 43 thus making said air spring 41 not only more compliant but more evenly compliant independent of position. Note that the view of the air spring 41 and reservoir 43 are not cross sectional.

FIG. 4b shows the back of the driver from FIG. 1, but instead of spring loaded levers it comprises an air spring 45 that uses negative air pressure, preferably within one psi above an absolute vacuum, to pull on the diaphragm 10 by pulling on tension members 46 that pull on the former 14, such an air spring can offer very high compliance. In this embodiment said air spring 45 is essentially a positive pressure air spring whose inside is exposed to the outside air thanks to an opening 45a and whose outside is exposed to a vacuum thanks to a cylindrical shell 45b.

Like a spring an added dc current through the voice coil may also center the diaphragm, to save energy the amplitude of this dc current may decrease (over a few seconds) as the amplitude of the ac current decreases.

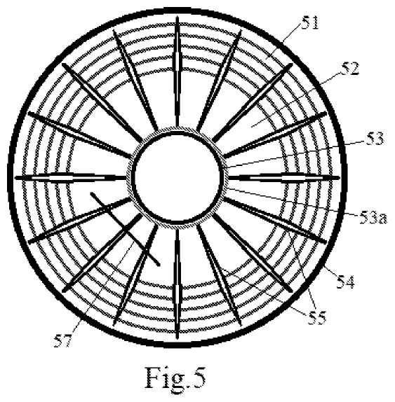

FIG. 5 shows the new type of spider 18 from FIGS. 1 and 2 that adds less mass and less stiffness to a speaker diaphragm, less mass and less stiffness is particularly helpful when a lightweight diaphragm is used. Said spider 18 comprises an outer area 51 that is corrugated or otherwise designed to elastically store potential energy, which may be pretensioned, and an inner area 52 that is relatively lightweight and mainly serves as (a) tension member(s) connecting the outer area 51 with the inner ring 53, this inner ring 53 may be glued directly to the voice coil's former, or it may be glued to the tension members 13 and short tension members 19 as seen in FIGS. 1 and 2, in which case said ring 53 may have a relatively large diameter. It is also possible that said spider 18 and said tension members 13 both comprise radial gaps which (as seen in FIG. 2) allows them to pass through each other without touching, in which case the inner area of the spider 18 replaces the short tension members 19 and connects directly to the voice coil former 14. Said spider 18 may even serve as a surround e.g. if the inner ring 53 is very large and is glued to the perimeter of a speaker diaphragm.

A possible outer (metal) ring 54 which can maintain tension on possible pretensioned area 51. Between the inner ring 53 and the inner area 52 there is an area 53a that offers strain relief e.g. it's less flexible near ring 53 and may become more flexible over several millimeters or more, this can prevent unacceptably sharp bending where inner ring 53 and inner area 52 meet. Possibly one or more radial gaps 55 or folds 55 which can provide space for when areas of the spider move inwards toward the center. One benefit of using folds 55 instead of gaps 55 is that it helps prevent shear movement between the separated sections, this can help keep the voice coil centered.

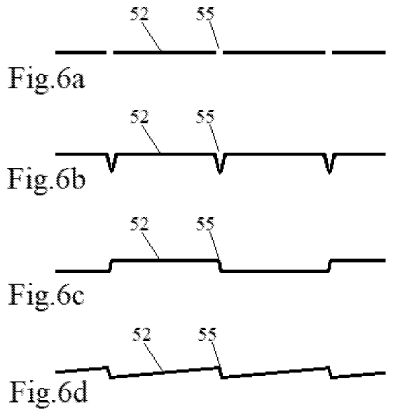

FIGS. 6a through 6d are cross sectional views of four possible sub embodiments of the spider in FIG. 5 when cut along line 57.

FIG. 6a shows inner areas 52 separated by gaps 55. If these gaps 55 are made wider they may allow the spider 18 to pass through the tension members 13 without touching, as mentioned a bit earlier.

FIG. 6b shows inner areas 52 separated by folds 55.

FIG. 6c shows inner areas 52 separated by folds 55.

FIG. 6d shows inner areas 52 separated by folds 55.

For the sake of the claims where on average inner area 52 has less mass per unit area (e.g. per square cm) than does outer area 51, let it be understood that area refers to the corresponding area along the flat plane of the spider and that extra area due to corrugations or folds etc. is NOT counted.

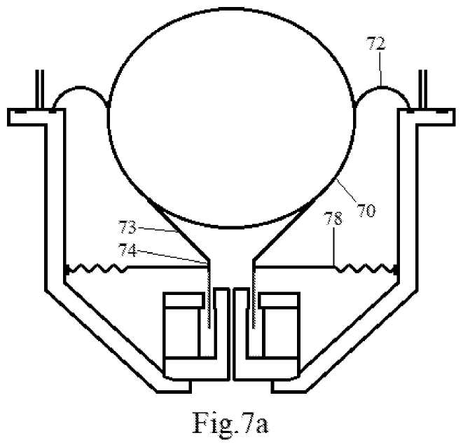

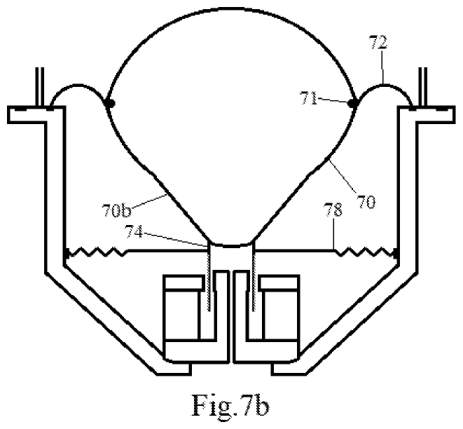

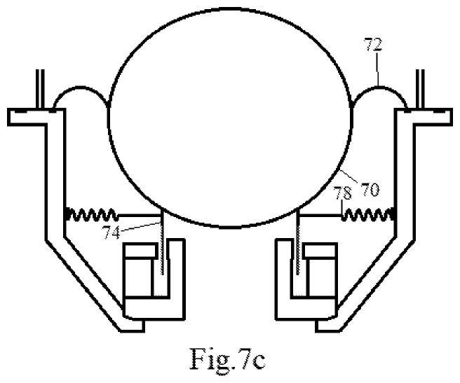

FIGS. 7a through 7c show speaker drivers comprising a pressurized bladder 70 that comprises a tensionally stiff sound producing layer 70 (i.e. being non stretch, having a relatively high Young's modulus) held taut by the air (gas) pressure difference, this allows the tensionally stiff layer 70 to maintain its shape while still being very lightweight, so any frequency speakers, including subwoofers, woofers, midranges and tweeters, may benefit from this. Said images show bladders 70 that are roughly spherical but many shapes are possible.

Since the only pressurized volume resides inside said bladder 70, the rest of the speaker, including the enclosure (not shown), need not be any different from a conventional speaker, and an air pump does not need to maintain a pressurized enclosure, however an air pump may be necessary to maintain the higher air pressure inside said bladder 70, a narrow flexible air tube may cross by way of the spider 78 (alongside the voice coil leads) allowing the pressure inside said bladder 70 to be controlled by a small air pump (not shown). For the back side of the bladder 70 to be taut the air pressure inside the enclosure (not seen) should not be the same as the air pressure inside the bladder 70, although the air pressure in the enclosure may be kept somewhat high perhaps for the sake of supporting the shape of the surround 72.

FIG. 7a shows an example of an embodiment where the voice coil former 74 is connected to the bladder 70 by way of a relatively small lightweight cone 73, this can ensure that the bladder 70 will not deform even though its internal air pressure is not very high, in this embodiment example the cone 73 need not block any air so it may be full of holes which may allow it to be very lightweight. The bladder 70 may comprise extra layers to make it stronger near where it connects to the cone 73 this can prevent fatigue.

FIG. 7b shows an example of an embodiment similar to the one in FIG. 7a but it illustrates two unrelated feature variations, one, the bladder 70 forms a flatter sphere so the bladder 70 is surrounded by a lightweight (possibly hollow) ring 71 that has relatively high compression stiffness, this ring 71 keeps tension off of the surround 72, two, the cone 70b is part of the bladder 70, the part of the bladder that forms the cone 70b may be thicker, therefore stronger and stiffer, than the rest of the bladder 70, it may comprise features similar to those in conventional speaker cones, e.g. ribs. A cone helps distribute the force on the bladder 70 from the former 74 so that the bladder 70 does not deform even though its internal air pressure is not very high. The cone can be very lightweight because it is relatively small and it is also supported in the same manner as is the rest of the bladder.

FIG. 7c shows an example of an embodiment where the diameter of the voice-coil-former 74 is not much smaller than the bladder 70 diameter and they are connected to each other directly without a cone or cone shape. This embodiment as well as the previous embodiments may also apply to microphones, i.e. rather than turning electricity into sound they may turn sound into electricity, however since the vibrations will be small the surrounds 72 may also be small, in some cases the surround may even be removed leaving a very narrow open air gap between the bladder and an enclosure that will resist airflow due to viscosity in laminar flow. Besides using a bladder or diaphragm held taut by an air (gas) pressure difference these microphones may resemble conventional microphones e.g. some of them may use an enclosure that is open in the back, or possibly no enclosure.

What is claimed is:

1. A speaker driver comprising:
a tensionally stiff diaphragm designed to be held taut and thus maintaining a shape and able to produce sound when said driver is mounted in a speaker enclosure that is pressurized, where said driver comprises means to keep at least some of the tension in said diaphragm from extending into the surround.

2. The speaker driver according to claim 1, wherein a lightweight ring, that has relatively high compression stiffness, surrounds said diaphragm and keeps at least some of the tension in said diaphragm from extending into the surround.

3. The speaker driver according to claim 1, wherein tensionally stiff tension members connect transducer means to said diaphragm forming an obtuse angle of at least one hundred and fifteen degrees between said tension members and said diaphragm thus diverting some of the tension away from said surround.

4. The speaker driver according to claim 1, where elastic i.e. spring means or magnetic means is used to pull on said diaphragm to counter the force of the air pressure, where leverage is used to allow substantially less movement of said spring(s) or magnet(s) than would be necessary without leverage.
